(19) United States
(12) Patent Application Publication
(10) Pub. No.: US 2016/0064039 A1
(43) Pub. Date: Mar. 3, 2016

(54) Thumbnail Generation

(71) Applicant: Microsoft Corporation, Redmond, WA (US)

(72) Inventors: Yongjun Wu, Bellevue, WA (US); Shyam Sadhwani, Bellevue, WA (US)

(21) Appl. No.: 14/469,457

(22) Filed: Aug. 26, 2014

(51) Int. Cl. G11B 27/34; G06K 9/00

(52) U.S. Cl. CPC G11B 27/34; G06K 9/00744

(57) ABSTRACT

Thumbnail generation techniques are described. In one or more implementations, at least one thumbnail is generated by a device from video received at the device. The generation of the at least one thumbnail includes decoding at least one I-picture included in the video when present that is to serve as a basis for the at least one thumbnail and skipping decoding of non-I-pictures that describe differences in relation to the at least one I-picture included in the video such that the non-I-pictures are not utilized in the generating of the at least one thumbnail. For robust thumbnail generation, when at least one I-picture has not been identified in the video in a predetermined time, falling back to decoding subsequent non-I-pictures in the video to generate the thumbnail from non-I-pictures.

### BACKGROUND

Users may consume video obtained from a variety of different sources utilizing a variety of different device configurations. For example, users may view video stored locally at a device, streamed from a service provider, and so on. Further, the users may utilize a variety of different devices to view this video, such as mobile computing devices, set-top boxes, portable music devices, traditional desktop personal computers, and so forth.

As part of the viewing experience, thumbnails may be generated to represent portions of the video, such as for representing the video in a file manager, for navigation to different portions of the video, and other uses. Conventional techniques that were utilized to generate thumbnails, however, needlessly consumed memory resources, had high latency, and were not robust in some instances due to treatment of the process in a manner that is similar to conformant sequential decoding defined in video coding standards.

### SUMMARY

Thumbnail generation techniques are described. In one or more implementations, at least one thumbnail is generated by a device from video received at the device. The generation of the at least one thumbnail includes decoding at least one I-picture included in the video that is to serve as a basis for the at least one thumbnail. Decoding of non-I-pictures that describe differences in relation to the at least one I-picture included in the video is skipped such that the non-I-pictures are not utilized in the generating of the at least one thumbnail.

In one or more implementations, a system includes one or more modules implemented at least partially in hardware. The one or more modules are configured to perform operations including generating at least one thumbnail from video received at the one or more modules. The generation of the at least one thumbnail includes examining the video to identify at least one I-picture in the video. Responsive to a determination that the at least one I-picture has been identified in the video, at least one I-picture included in the video is decoded to serve as a basis for the generating of at least one thumbnail. Responsive to a determination that the at least one I-picture has not been identified in the video in a predetermined time, a fall back is performed to decode subsequent non-I-pictures in the video to generate the thumbnail.

In one or more implementations, a system includes one or more modules implemented at least partially in hardware. The one or more modules are configured to perform operations including generating at least one thumbnail from video received at the one or more modules. The generation of the at least one thumbnail includes identifying at least one I-picture included in the video that is to serve as a basis for the generating of the thumbnail and responsive to the identifying, decoding the at least one I-picture without processing of the at least one I-picture using decoded picture buffering.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ thumbnail generation techniques.

FIG. 2 depicts a system in an example implementation showing operation of a thumbnail module of FIG. 1 in greater detail.

FIG. 3 is a flow diagram depicting a procedure in an example implementation in which a thumbnail is generated without employing decoded picture buffering.

FIG. 4 is a flow diagram depicting a procedure in an example implementation in which decoding of non-I-pictures in video is skipped as part of thumbnail generation.

FIG. 5 is a flow diagram depicting a procedure in an example implementation in which a fallback to use of non-I-pictures to generate a thumbnail is performed in response to lack of identification of an I-picture in video in a predefined time.

FIG. 6 illustrates an example system including various components of an example device that can be implemented as any type of computing device as described with reference to FIGS. 1-5 to implement embodiments of the techniques described herein.

### DETAILED DESCRIPTION

### Overview

Thumbnail generation has been an integral part of consumption of video, such as to act as an aid to navigation by representing portions of the video and even the represent the video itself, such as through use of an icon or tile. Convention techniques that are utilized to generate thumbnails, however, often follow techniques that are conformant to sequential decoding in accordance with video encoding techniques such as H.264/MPEG-4 AVC or High Efficiency Video Coding (HEVC/H.265). As such, these conventional techniques needlessly consume memory resources, have high latency, and are not robust in some instances.

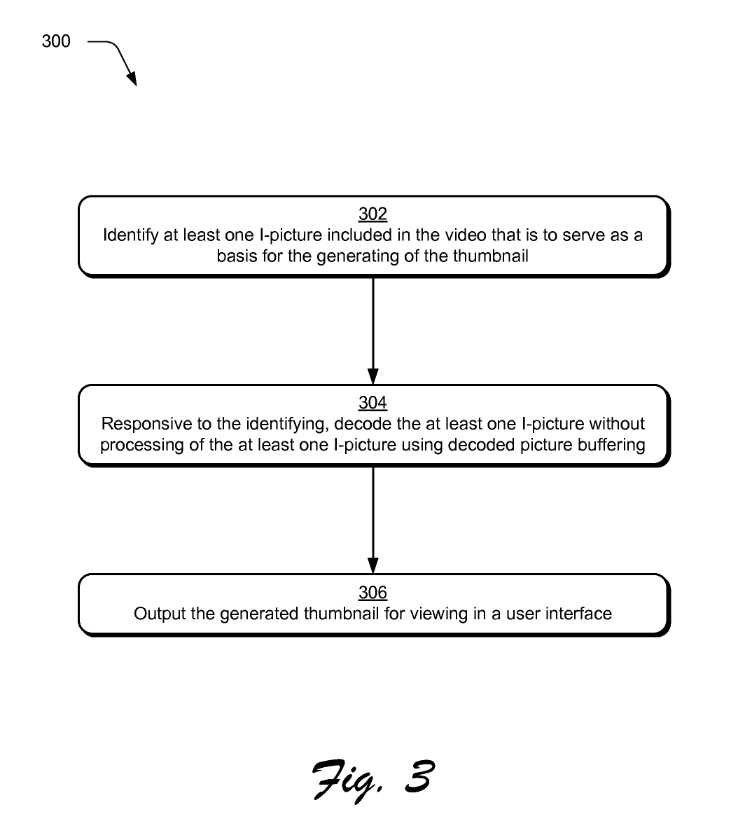

Thumbnail generation techniques are described. In one or more implementations, thumbnail generation is performed using a non-conformant decoding process such that decoded picture buffering (DPB) defined in video coding standards is avoided. This may be performed such that upon identification of an I-picture in the video that I-picture is decoded without use of a decoded picture buffer and thus reduce decoding latency, further discussion of which may be found in relation to FIG. 3.

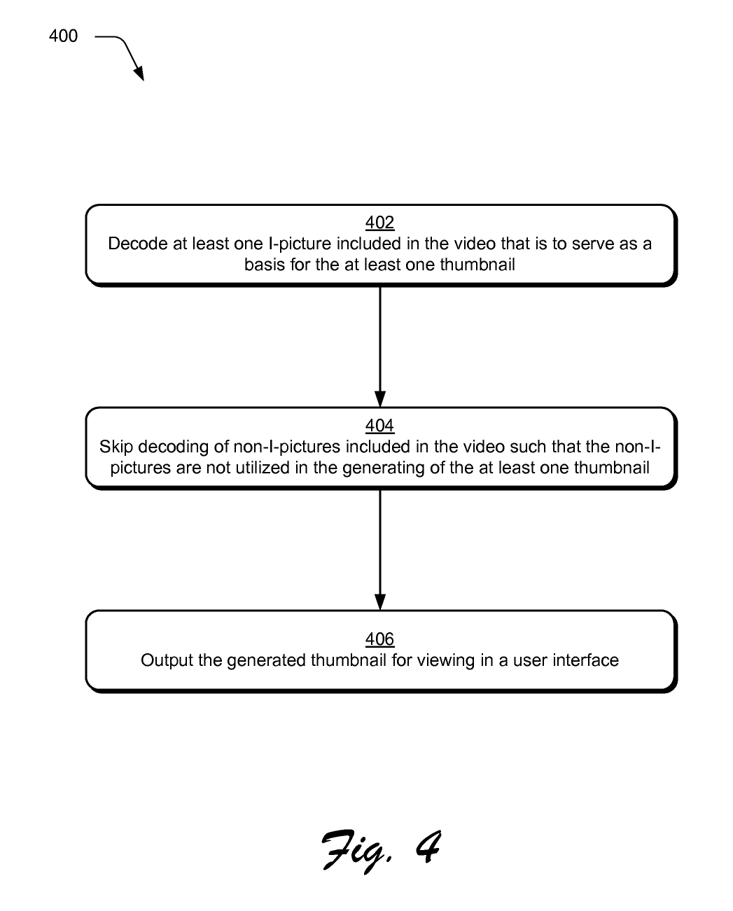

Additionally, the decoded I-picture may be used to generate the thumbnail while decoding of subsequent non-I-pictures (e.g., P or B pictures) is avoided. For example, the I-picture may be utilized to generate the thumbnail without use of associated non-I-pictures, e.g., P or B pictures. The thumbnail may then be utilized the represent the I-picture and may be repeated for the associated non-I-pictures, e.g., through use of a bob deinterlacing process, further discussion of which may be found in relation to FIG. 4.

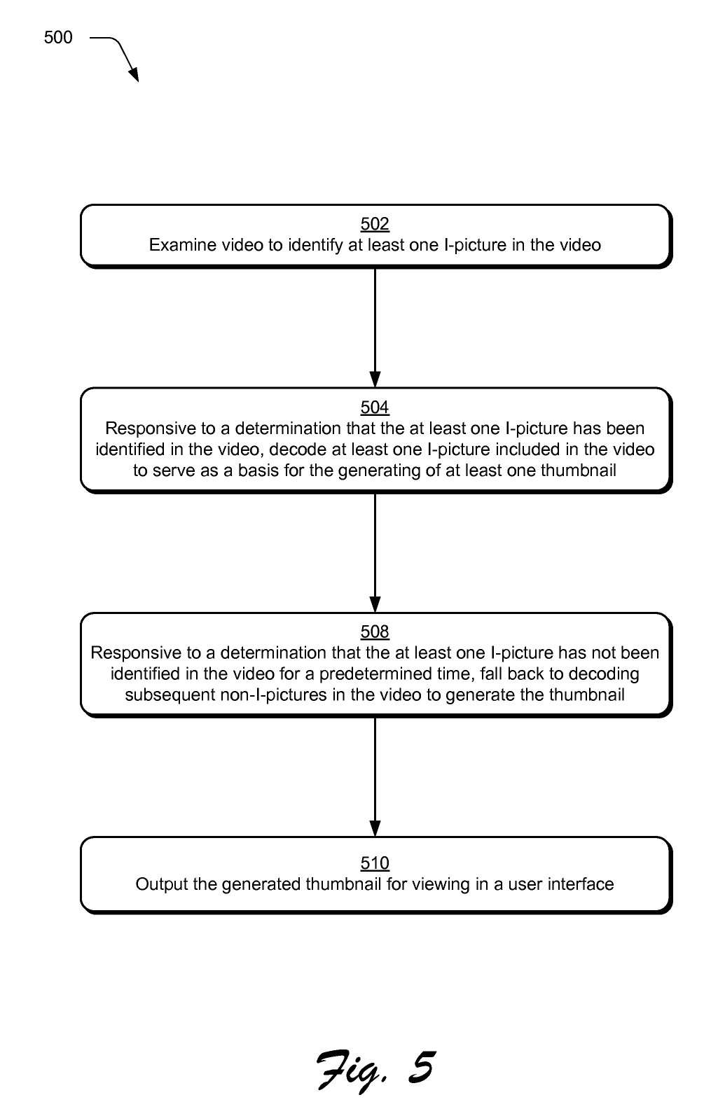

Further, fallback techniques may be employed as part of thumbnail generation. In some instance, video may be examined for a predefined time (e.g., amount of time, number of pictures, and so on) to locate an I-picture. If an I-picture is not located in that predefined time, fallback techniques may be initiated to buffer (e.g., decoded picture buffering DPB) non-I-frames for use in generating the thumbnail, further discussion of which may be found in relation to FIG. 5.

Further discussion of these and other thumbnail generation techniques may be found in relation to the following sections. In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

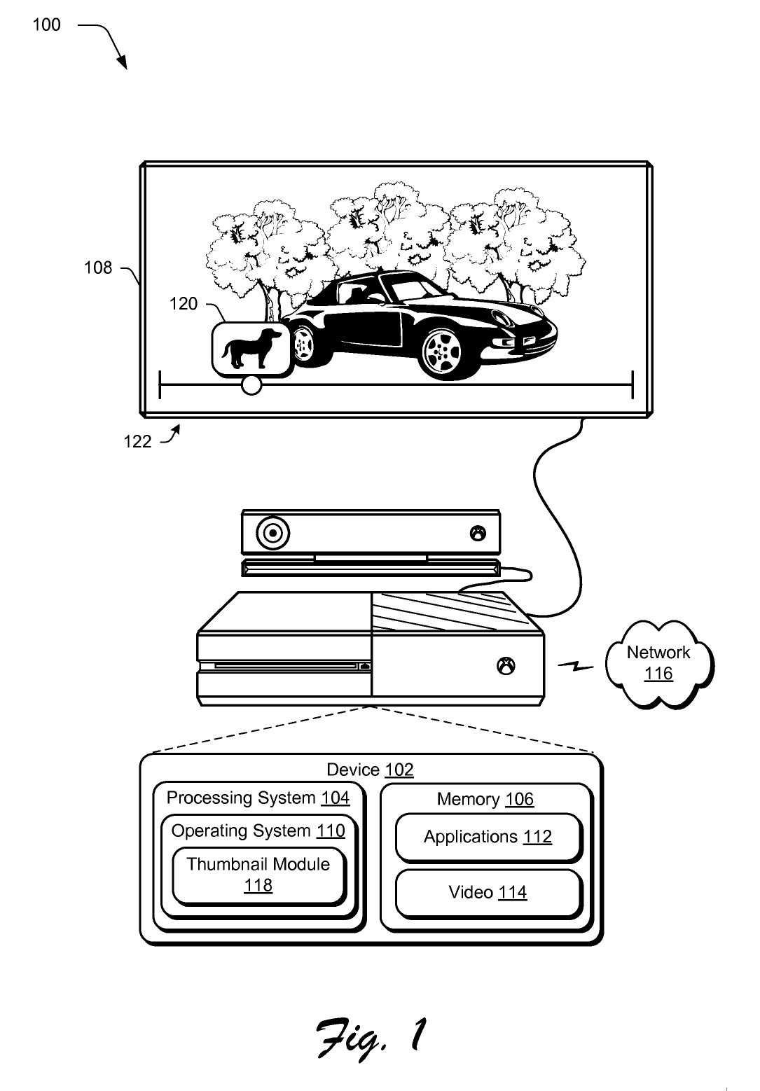

FIG. 1 is an illustration of an environment 100 in an example implementation that is operable to employ the thumbnail generation techniques described herein. The illustrated environment 100 includes a device 102, which may be configured in a variety of ways. For example, the device 102 may be configured as a computing device, such as a desktop computer, a mobile station, an entertainment appliance, a mobile computing device having a housing configured in accordance with a handheld configuration (e.g., a mobile phone or tablet), a set-top box communicatively coupled to a display device, a wireless phone, a game console as illustrated, and so forth.

Thus, the device 102 may range from full resource devices with substantial memory and processor resources (e.g., personal computers, game consoles) to a low-resource device with limited memory and/or processing resources (e.g., traditional set-top boxes, hand-held game consoles). Additionally, although a single device 102 is shown, the device 102 may be representative of a plurality of different devices, such as multiple servers utilized by a business to perform operations such as by a web service, a remote control and set-top box combination, an image capture device and a game console configured to capture gestures as illustrated, and so on.

The device 102 is illustrated as including a processing system 104, an example of a computer-readable storage medium illustrated as memory 106, and a display device 108. The processing system 104 is representative of functionality to perform operations through execution of instructions stored in the memory 106. Although illustrated separately, functionality of these components may be further divided, combined (e.g., on an application specific integrated circuit), and so forth.

The device 102 is further illustrated as including an operating system 110. The operating system 110 is configured to abstract underlying functionality of the device 102 to applications 112 that are executable on the device 102. For example, the operating system 110 may abstract processing system 104, memory 106, network, and/or display 108 functionality of the computing device 102 such that the applications 112 may be written without knowing “how” this underlying functionality is implemented. The application 112, for instance, may provide data to the operating system 110 to be decoded, rendered and displayed by the display device 108 without understanding how this rendering will be performed. The operating system 110 may also represent a variety of other functionality, such as to manage a file system and user interface that is navigable by a user of the device 102.

The device 102 is also illustrated as including video 114 that may be rendered for display on the display device 108. Although the video 114 is illustrated as stored in memory 106, the video 114 may be obtained from a variety of other sources, such as remotely via a network 116. The video 114 may be encoded according to a variety of different video coding standards to support efficient transfer via the network 116 and/or storage in memory 106. Examples of such video coding standards include H.264/MPEG-4 AVC or High Efficiency Video Coding (HEVC). In these standards, decoded picture buffering (DPB) is utilized in conventional implementations in which a number of pictures (e.g., frames, fields, slices, and so on) is stored in a buffer and decoded before output for display by the display device.

A thumbnail module 118 is illustrated that is representative of functionality to generate a thumbnail 120 for output to and display by the display device 108. The thumbnail 120 may be configured as a reduced size version of pictures included in the video 114. Thumbnails 120 may be utilized for a variety of different purposes, such as to reduce bandwidth and download time, to represent the video 114 (e.g., an icon or tile) or portions of the video 114 (e.g., for navigation through the video 114 such as through use of navigation bar 122), and so forth. Although the thumbnail module 118 is illustrated as part of an operating system 110 such that applications 112 and other functionality of the device 102 may leverage these techniques without being aware of how the techniques are performed as previously described, it should be readily apparent that functionality represented by the thumbnail module 118 may be configured as a stand-alone application, incorporated as part of the one or more applications 112, implemented as part of a web service via a network 116, via dedicated hardware, and so forth.

As previously described, conventional techniques that are utilized to generate a thumbnail are conformant with standards that employ decoded picture buffering. As such, increased memory usage and decoding latency involved in use of the decoded picture buffering (DPB) may also be involved in the generation of thumbnails. The thumbnail module 118, however, may be configured to support techniques that reduce and even eliminate these limitations and therefore increase efficiency and reduce latency in thumbnail generation, further discussion of which may be found in the following description and shown in a corresponding figure.

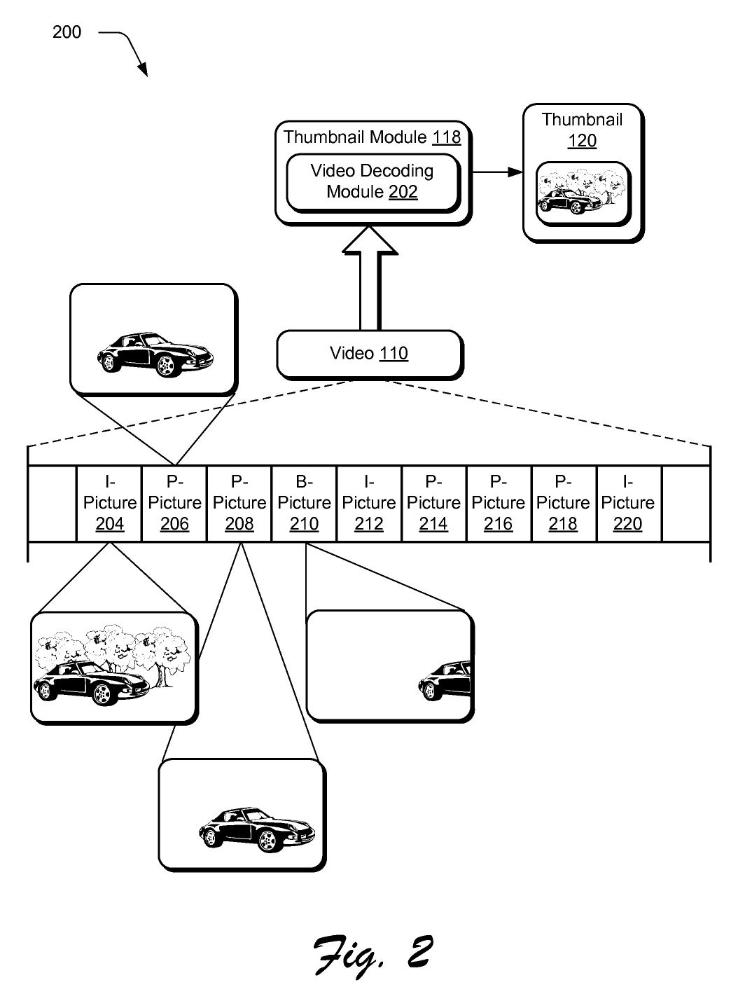

FIG. 2 depicts a system 200 in an example implementation showing operation of the thumbnail module 118 in greater detail. In this example, the thumbnail module 118 is illustrated as including a video decoding module 202 that is representative of functionality to decode video 110. As before, although illustrated as part of the thumbnail module 118, it should be readily apparent that functionality represented by the video decoding module 202 may be configured as a stand-alone application, incorporated as part of the operating system 110 and/or one or more applications 112, implemented as part of a web service via a network 116, and so forth.

The video 110 is illustrated as including a plurality of pictures 204-220 that are typically decoded and then displayed in sequence by the video decoding module 202 for rendering by the display device 108 of FIG. 1. Examples of pictures include frames, fields, and slices, e.g., in accordance with H.264/MPEG-4 AVC, High Efficiency Video Coding (HEVC), and so forth.

The video 110, for instance, may be encoded using one or more video compression algorithms to compress the video 110 for communication via a network 116 and/or storage in memory 106. The plurality of pictures 204-220 included in the video 110 may take a variety of different forms. I-pictures 204, 212, 220, for instance, are an “intra-coded picture” that is fully specified in a manner that is similar to a conventional static image file. Thus, I-pictures 204, 212, 220 have content that is solely defined by that respective I-picture.

Non-I-pictures are also included in the video 110. For example, P-pictures 206, 208, 214, 216, 218 may leverage data from previous pictures in the sequence to define content for that picture and thus are more compressible that I-pictures. P-pictures, for instance, 206, 208, 214, 216, 218 are also known as “predicted pictures” that describe changes in the data from a previous picture.

Consider an example in which the video 110 includes a scene in which a car moves across a stationary background. As illustrated, I-picture 204 includes data that describes the car and the background that includes trees. P-picture 206 describes movement of the car, and thus the car's movement is encoded in the P-picture 206 and the background is not, thus conserving memory. Likewise, P-picture 208 also further describes movement of the car, and thus the car's movement is encoded in the P-picture 208 and the background is not encoded by leveraging data from previous pictures in the sequence of the video 110.

The video 110 is also illustrated as included B-pictures 208. A B-picture 208 is a “bi-predictive picture” that may leverage data from both previous and subsequent pictures in the video 110. As illustrated, for instance, B-picture 208 may leverage data from a previous picture (e.g., P-picture 208) in the sequence of the video 110 as well as data from a subsequent picture (e.g., I-Picture 212) to describe data for inclusion in the B-picture 210.

The thumbnail module 118 may be configured to leverage differences in the picture types for decoding by the video decoding module 202 as part of generation of the thumbnail 120. The thumbnail module 118, for instance, may employ techniques that improve efficiency in memory usage in the generation of the thumbnail over conventional techniques. For example, video coding standards may define a conformant process for typical sequential decoding starting with a perfect instantaneous decoding refresh (IDR) picture. Conventional thumbnail generation techniques followed this process using decoded picture buffering (DPB) techniques.

In decoded picture buffering, previously decoded pictures are stored and used to form predictions for subsequent pictures, e.g., as part of HEVC or other standards. A maximum number of pictures that are stored in a decoded picture buffer is referred to as a capacity for the buffer, e.g., which may include four pictures, six pictures, eight pictures, and so on. Thus, conventional techniques that generated thumbnails through use of a decoded picture buffer may introduce latency in the decoding and filling of the buffer for use in generating the thumbnail.

The thumbnail module 118, however, may be configured such that thumbnails 120 may be generated without use of the decoded picture buffer. For example, the thumbnail module 118 may be configured to identify I-pictures 204, 212, 220 included in the video 110. Once identified, the I-picture 204, 212, 220 is decoded and output immediately by the video decoding module 202 for generation of the thumbnail 120 by the thumbnail module 118 without DPB buffering in a low latency mode of one in/one out. For example, the thumbnail module 118 may reduce a size/resolution of the I-pictures 204, 212, 220 for use as the thumbnail 120 without using other pictures as these pictures are self-contained.

In this way, latency introduced by DPB buffering may be avoided and memory usage efficiency increased. For example, at a 1080p resolution, memory usage may be reduced by approximately fifteen megabytes and latency may be reduced by a capacity of the decoded picture buffer, e.g., latency introduced by decoding four pictures for a decoded picture buffer having a capacity of four. Further discussion of this technique may be found in relation to FIG. 3.

The thumbnail module 118 may also be configured to support other performance optimizations based on the type of pictures in the video 110. For example, the thumbnail module 118 as before may be configured to identify I-pictures 204, 212, 220 in the video 110. Once identified, these I-pictures 204, 212, 220 may be decoded by the video decoding module 202 to serve as a basis for generating a respective thumbnail 120 as before.

Additionally, the thumbnail module 118 may also be configured to skip decoding of non-I-pictures that describe differences in relation to the I-picture. For example, the thumbnail module 118 may leverage the video decoding module 202 to decode I-picture 204 for use in generating the thumbnail 120.

The thumbnail module 118 may also skip decoding of the P-pictures 206, 208 and B-picture 210 for thumbnail generation and thus resource consumption involved in decoding those pictures and generating thumbnails from those picture may be avoided. For instance, the thumbnail module 118 may utilize the thumbnail 120 generated for the I-picture 204 to also represent the P-pictures 206, 208 and B-picture 210, by following a bob deinterlacing process. In this way, latency and resource consumption involved in decoding the non-I-frames may be avoided, further discussion of which may be found in relation to FIG. 4.

Further, the thumbnail module 118 may also be configured to support robust generation of the thumbnail 120. Like before, the thumbnail module 118 and corresponding video decoding module 202 may examine the video 110 to locate I-pictures for thumbnail generation. In some instances, however, I-pictures may not be present. Accordingly, the thumbnail module 118 may be configured to fall back to usage of decoded picture buffering in which non-I-pictures are buffered and utilized to generate the thumbnail 120.

The thumbnail module 118, for instance, may be configured to examine the video 110 for a predefined time. The predefined time may be defined in a variety of ways, such as an amount of time (e.g., three seconds), a number of consecutive pictures in the video 110 (e.g., ninety pictures), and so forth. The thumbnail module 118, for instance, may keep count of a number of pictures searched as part of the examination of the video 110 for an I-picture.

After a predefined number “α” is reached (e.g., where “α” is three seconds worth of pictures such as ninety pictures), but an I-picture is still not located, the thumbnail module 118 may fall back to use of decoded picture buffering using non-I-pictures and keep decoding for another predefined time “β,” where “β” may also be defined as an amount of time (e.g., one second), a number of consecutive pictures in the video 110 (e.g., thirty pictures), and so forth. In one or more implementations, the thumbnail module 118 may be configured to generate thumbnails once a defined number of pictures are stored in the decoded picture buffer to in order to build up the quality of the pictures used to generate the thumbnail. Further discussion of this technique may be found in relation to FIG. 5.

### Example Procedures

The following discussion describes thumbnail generation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

Functionality, features, and concepts described in relation to the examples above may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

FIG. 3 depicts a procedure 300 in an example implementation in which a thumbnail is generating without employed decoded picture buffering. A thumbnail module 118 of the device 102 is employed to generate at least one thumbnail. The generation of the at least one thumbnail includes identifying at least one I-picture included in the video that is to serve as a basis for the generating of the thumbnail (block 302). The thumbnail module 118, for instance, may examine the video 110 to locate I-pictures 204, 212, 220 encoded as part of the video 110.

Responsive to the identification, the at least one I-picture is decoded without processing of the at least one I-picture using decoded picture buffering (block 304). Continuing with the previous example, the thumbnail module 118 may identify I-picture 204 and leverage the video decoding module 220 to decode the I-picture 204 immediately without having the I-picture “pass through” a decoded picture buffer. The generated thumbnail is then output for viewing in a user interface (block 306). In this way, the thumbnail may be generated without the latency introduced by a decoded video buffer as is experienced using conventional techniques.

FIG. 4 depicts a procedure 400 in an example implementation in which decoding of non-I-pictures in video is skipped as part of thumbnail generation. As before, a thumbnail module 118 of the device 102 is employed to generate at least one thumbnail from the video 110. The generation of the at least one thumbnail includes decoding at least one I-picture included in the video that is to serve as a basis for the at least one thumbnail (block 402). Thus, like FIG. 3 the thumbnail may be generated from an I-picture, and may do so directly without use of a decoded video buffer to reduce latency.

In this example, decoding of non-I-pictures that describe differences in relation to the at least one I-picture included in the video is skipped such that the non-I-pictures are not utilized in the generating of the at least one thumbnail (block 404). The generated thumbnail is output for viewing in the user interface (block 406). As shown in FIG. 2, for instance, I-picture 204 may be decoded and used as a basis to generate thumbnail 120 by the thumbnail module 118. However, decoding of P-pictures 206, 208 as well as B-picture 210 may be skipped, which have content that is dependent either directly or indirectly from I-picture 204. The thumbnail 120, for instance, may be utilized to represent each of the pictures and thus use of resources of the device 102 may be conserved.

FIG. 5 depicts a procedure 500 in an example implementation in which a fallback to use of non-I-pictures to generate a thumbnail is performed in response to lack of identification of an I-picture in video in a predefined time. As before, a thumbnail module 118 of the device 102 is employed to generate at least one thumbnail from video 110. The generation of the at least one thumbnail includes examining the video to identify at least one I-picture in the video (block 502). Responsive to a determination that the at least one I-picture has been identified in the video, at least one I-picture included in the video is decoded to serve as a basis for the generating of at least one thumbnail (block 504). Thus, like FIG. 3 the thumbnail may be generated from an I-picture, and may do so directly without use of a decoded video buffer to reduce latency. Also, techniques of FIG. 4 may also be employed to skip decoding of subsequent non-I-frames in the video 110 to conserve resources of the device 102.

Responsive to a determination that the at least one I-picture has not been identified in the video in a predetermined time, a fall back is performed to decode subsequent non-I-pictures in the video to generate the thumbnail. (block 508). The predetermined time, for instance, may be defined as an amount of time (e.g., thirty seconds), by a number of pictures received, and so forth. If an I-picture is not found during this time, subsequent pictures may be utilized to generate the thumbnail, such as a collection of non-I-pictures collected in a decoding picture buffer. Regardless of how generated, the generated thumbnail is then output for viewing in a user interface (block 510). Thus, in this way the thumbnail module 118 may provide a robust thumbnail generation that supports efficient usage of memory and processing resources of the device 102.

### Example System and Device

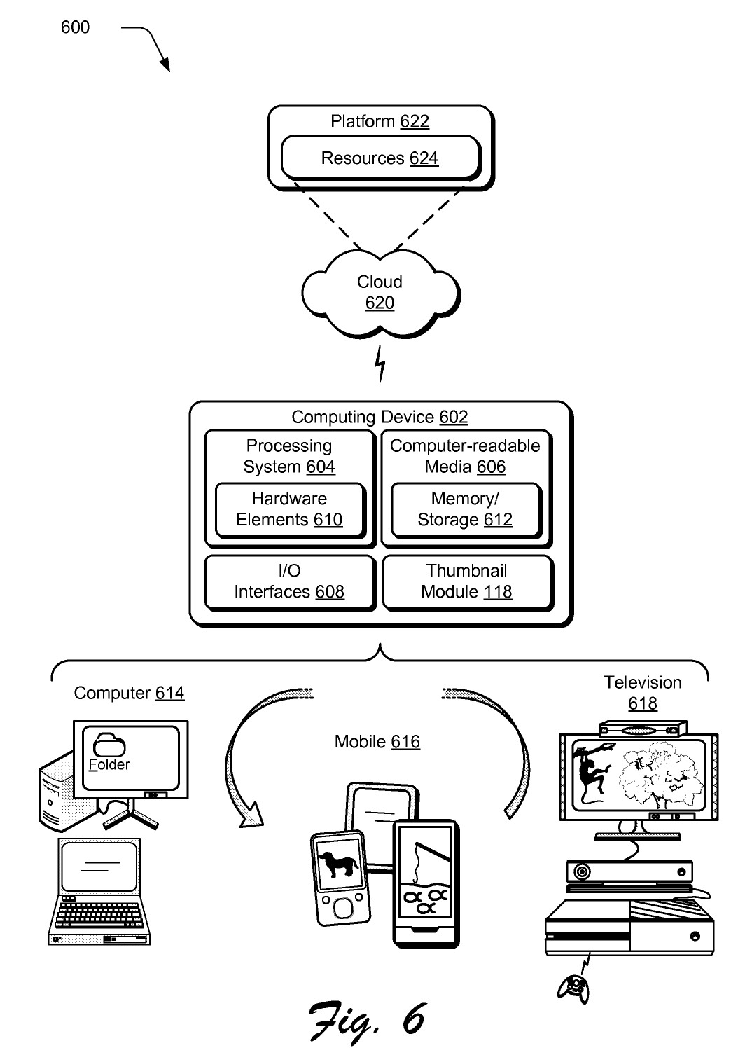

FIG. 6 illustrates an example system generally at 600 that includes an example computing device 602 that is representative of one or more computing systems and/or devices that may implement the various techniques described herein. An example of this is illustrated through inclusion of the thumbnail module 118. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This functionality may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
generating at least one thumbnail by a device from video received at the device, the generating of the at least one thumbnail including:
decoding at least one I-picture included in the video that is to serve as a basis for the at least one thumbnail; and
skipping decoding of non-I-pictures that describe differences in relation to the at least one I-picture included in the video such that the non-I-pictures are not utilized in the generating of the at least one thumbnail

2. A method as described in claim 1, wherein the thumbnail is a reduced size version of one or more pictures included as part of the video.

3. A method as described in claim 1, wherein the thumbnail generated from the decoded at least one I-picture is utilized to represent the at least one I-picture and the non-I-pictures included in the video.

4. A method as described in claim 3, wherein the thumbnail is utilized to represent the non-I-pictures included in the video using a bob de-interlacing process for interlaced images.

5. A method as described in claim 1, wherein the non-I-pictures:
are arranged sequentially in the video before or after the at least one I-picture; and
describe differences in relation to the at least one I-picture or one or more other non-I-pictures that describe differences in relation to the at least one I-picture.

6. A method as described in claim 5, wherein the non-I-pictures include a predicted picture that describes differences from a previous picture in the video or a bi-predictive picture that describes differences from both a previous picture in the video and a following picture in the video.

7. A method as described in claim 1, further comprising:
identifying the at least one I-picture included in the video that is to serve as a basis for the generating of the thumbnail; and
responsive to the identifying, decoding the at least one I-picture without processing of the at least one I-picture using decoded picture buffering.

8. A method as described in claim 1, further comprising:
examining the video for a predetermined time; and
responsive to a determination that the I-picture has not been identified in the video for the predetermined time as part of the examining, falling back to decoding subsequent non-I-pictures in the video to generate the thumbnail.

9. A method as described in claim 8, wherein the predetermined time is specified as a number of sequential pictures included in the video or an amount of time.

10. A method as described in claim 1, wherein the pictures are configured as frames, fields or slices as part of the video.

11. A method as described in claim 1, wherein the video is configured in accordance with H.264/MPEG-4 AVC or High Efficiency Video Coding (HEVC/H.265).

12. A system comprising:
one or more modules implemented at least partially in hardware, the one or more modules configured to perform operations including generating at least one thumbnail from video received at the one or more modules, the generating of the at least one thumbnail including:
examining the video to identify at least one I-picture in the video;
responsive to a determination that the at least one I-picture has been identified in the video, decoding at least one I-picture included in the video to serve as a basis for the generating of at least one thumbnail; and
responsive to a determination that the at least one I-picture has not been identified in the video in a predetermined time, falling back to decoding subsequent non-I-pictures in the video to generate the thumbnail.

13. A system as described in claim 12, wherein the falling back includes use of decoded picture buffering to buffer a plurality of non-I-pictures to be used in the generation of the at least one thumbnail.

14. A system as described in claim 12, further comprising responsive to a determination that the at least one I-picture has been identified in the video, skipping decoding of non-I-pictures included in the video such that the non-I-pictures are not utilized in the generating of the at least one thumbnail.

15. A system as described in claim 12, wherein the predetermined time is specified as a number of sequential pictures included in the video or an amount of time.

16. A system as described in claim 12, wherein:
the pictures are configured as frames, fields or slices as part of the video; and
the non-I-pictures are arranged sequentially in the video in relation to the at least one I-picture and describe differences in relation to the at least one I-picture that describe differences in relation to the at least one I-picture.

17. A system as described in claim 12, wherein the video is configured in accordance with H.264/MPEG-4 AVC or High Efficiency Video Coding (HEVC/H.265).

18. A system comprising:
one or more modules implemented at least partially in hardware, the one or more modules configured to perform operations including generating at least one thumbnail from video received at the one or more modules, the generating of the at least one thumbnail including:
identifying at least one I-picture included in the video that is to serve as a basis for the generating of the thumbnail; and
responsive to the identifying, decoding the at least one I-picture without processing of the at least one I-picture using decoded picture buffering.

19. A system as described in claim 18, wherein the video and the decoded picture buffering are configured in accordance with H.264/MPEG-4 AVC or High Efficiency Video Coding (HEVC/H.265).

20. A system as described in claim 18, further comprising responsive to a determination that the at least one I-picture has been identified in the video, skipping decoding of non-I-pictures included in the video such that the non-I-pictures are not utilized in the generating of the at least one thumbnail.
